(19) United States
(12) Patent Application Publication
(10) Pub. No.: US 2017/0039029 A1
(43) Pub. Date: Feb. 9, 2017

(54) SPEAKER

(71) Applicant: Harman International Industries, Incorporated, Stamford, CT (US)

(72) Inventors: Damian Heinrich Mackiewicz, Shanghai (CN); Alexander Demin, Shanghai (CN); Hunglin Hsu, Shanghai (CN); Haoyu Li, Shanghai (CN); Liying Hu, Shanghai (CN); Rongjian Huang, Shanghai (CN); Shufen Guo, Shanghai (CN)

(73) Assignee: Harman International Industries, Incorporated, Stamford, CT (US)

(21) Appl. No.: 15/303,509

(22) PCT Filed: May 5, 2014
(86) PCT No.: PCT/CN2014/076776

§ 371 Date: Oct. 11, 2016

(51) Int. Cl. G06F 3/16; G01B 7/14; G06F 3/01

(52) U.S. Cl. CPC G06F 3/165; G06F 3/017; G01B 7/14

(57) ABSTRACT

A speaker is provided. The speaker may include: a sensor adapted to sensing object movement within its sensing range; and a processing device configured to generate a volume control instruction if the sensor senses one of the following movements of an object: movement away from the first sensor, and movement towards the first sensor. More intuitive and easy-to-understand ways to control playback of the media player may be achieved.

### TECHNICAL FIELD

The present disclosure generally relates to a speaker, and more particularly, to a gesture control speaker.

### BACKGROUND

Gesture control media players are getting more and more popular. People can control such players by posing specific predefined gestures to implement various functions, such as play, pause, skip tracks, etc. To improve user experience, more intuitive and easy-to-understand ways to control playback of media players are required.

### SUMMARY

In one embodiment, a speaker is provided. The speaker may include: a sensor adapted to sensing object movement within its sensing range; and a processing device configured to generate a volume control instruction if the sensor senses one of the following movements of an object: movement away from the sensor, and movement towards the sensor.

In some embodiments, the speaker may be integrated with a media player. In some embodiments, the speaker may be separated from a media player and may include an interface adapted to communicating with the media player.

In some embodiments, the processing device may be configured to: generate a first volume control instruction to increase volume if the sensor senses the object's movement away from the sensor; and generate a second volume control instruction to decrease volume if the sensor senses the object's movement towards the sensor. In some embodiments, the processing device may be configured to: generate the first volume control instruction to increase volume if the sensor senses the object's movement towards the sensor; and generate the second volume control instruction to decrease volume if the sensor senses the object's movement away from the sensor.

In some embodiments, the processing device may be further configured to: generate the volume control instruction to change volume to an extent based on a distance the object moves which is sensed by the sensor.

In some embodiments, the processing device may be further configured to: determine whether the sensor senses the object staying still for at least a predetermined period of time before sensing the movement away from the sensor of the object or the movement towards the sensor of the object; and if yes, generate the volume control instruction based on the movement away from the sensor of the object or the movement towards the sensor of the object.

In some embodiments, the processing device may be configured to: if the sensor senses the object staying still for at least the predetermined period of time, control the speaker to give an audible or visible notice for reminding a user to move the object.

In one embodiment, a speaker is provided. The speaker may include: a sensor adapted to sensing a distance between the sensor and an object in a sensing range of the sensor; and a processing device configured to generate a volume control instruction based on the distance sensed by the sensor.

In some embodiments, the speaker may be integrated with a media player. In some embodiments, the speaker may be separated from a media player and may include an interface adapted to communicating with the media player.

In some embodiments, the processing device may be configured to: generate a first volume control instruction to increase volume if the distance sensed by the sensor increases; and generate a second volume control instruction to decrease volume if the distance sensed by the sensor decreases. In some embodiments, the processing device may be configured to: generate the first volume control instruction to increase volume if the distance sensed by the sensor decreases; and generate the second volume control instruction to decrease volume if the distance sensed by the sensor increases.

In some embodiments, the processing device may be further configured to: if the distance sensed by the sensor changes, generate the volume control instruction to change volume to an extent based on how much the distance changes.

In some embodiments, the processing device may be further configured to: determine whether the distance sensed by the sensor remains still for at least a predetermined period of time before the distance changes; and if yes, generate the volume control instruction based on a change of the distance.

In some embodiments, the processing device may be configured to: if the distance sensed by the sensor remains for at least the predetermined period of time, control the speaker to give an audible or visible notice for reminding a user to change the distance.

In one embodiment, a speaker is provided. The speaker may include: a sensor adapted to sensing the speaker rotating; and a processing device adapted to generating a control instruction to control a media player to play a next file or a previous file based on the rotating direction of the speaker sensed by the sensor.

In one embodiment, a speaker is provided. The speaker may include: a sensor adapted to sensing the speaker shaking; and a processing device adapted to generating a control instruction to control a media player to shuffle its playlist if the sensor senses the speaker shaking.

In one embodiment, a gesture control device for controlling an audio system is provided. The gesture control device may include: a sensor for sensing object movement within its sensing range; and a processing device configured to generate a corresponding volume control instruction to control the volume of the audio system if the sensor senses one of the following movements of an object: movement away from the sensor, and movement towards the sensor.

In some embodiments, the processing device may be further configured to: generate a first volume control instruction to increase volume if the sensor senses the object's movement away from the sensor; and generate a second volume control instruction to decrease volume if the sensor senses the object's movement towards the sensor. In some embodiments, the processing device may be configured to: generate the first volume control instruction to increase volume if the sensor senses the object's movement towards the sensor; and generate the second volume control instruction to decrease volume if the sensor senses the object's movement away from the sensor.

In some embodiments, the processing device may be further configured to: generate the volume control instruction to change volume of the audio system to an extent based on a distance the object moves which is sensed by the sensor.

In some embodiments, the processing device may be further configured to: determine whether the sensor senses the object staying still for at least a predetermined period of time before sensing the movement away from the sensor of the object or the movement towards the sensor of the object; and if yes, generate the volume control instruction based on the movement away from the sensor of the object or the movement towards the sensor of the object.

In some embodiments, the processing device may be configured to: if the sensor senses the object staying still for at least the predetermined period of time, control the gesture control device to give an audible or visible notice for reminding a user to move the object.

In one embodiment, a method for controlling an audio system based on gesture is provided. The method may include: a control device sensing movements of an object in its sensing range; and generating a corresponding volume control instruction to control the volume of the audio system if one of the following movements of an object is sensed: movement away from the control device, and movement towards the control device.

In some embodiments, the control device may generate a first volume control instruction to increase the volume of the audio system if the object's movement away from the control device is sensed; and generate a second volume control instruction to decrease the volume of the audio system if the object's movement towards the control device is sensed. In some embodiments, the control device may generate the first volume control instruction to increase the volume of the audio system if the object's movement towards the control device is sensed; and generate the second volume control instruction to decrease the volume of the audio system if the object's movement away from the control device is sensed.

In some embodiments, the control device may generate the volume control instruction to change the volume of the audio system to an extent based on a distance the object moves which is sensed by the control device.

In some embodiments, the method may further include: the control device determining whether the object stays still for at least a predetermined period of time before the movement away from the control device of the object or the movement towards the control device of the object is sensed; and if yes, generating the volume control instruction based on the movement away from the control device of the object or the movement towards the control device of the object.

In some embodiments, the method may further include: if the object stays still for at least the predetermined period of time, the control device giving an audible or visible notice for reminding a user to move the object.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 schematically illustrates a playback system according to one or more embodiments; and

FIG. 2 schematically illustrates a block diagram of a speaker according to one or more embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Users may control playback of a media player by posing specific gestures. However, it may be troublesome for the user to remember multiple gestures to implement various operations, such as play, pause, increase volume, decrease volume, play a next file, play a previous file, and the like. Therefore, more intuitive and easy-to-understand gestures are needed.

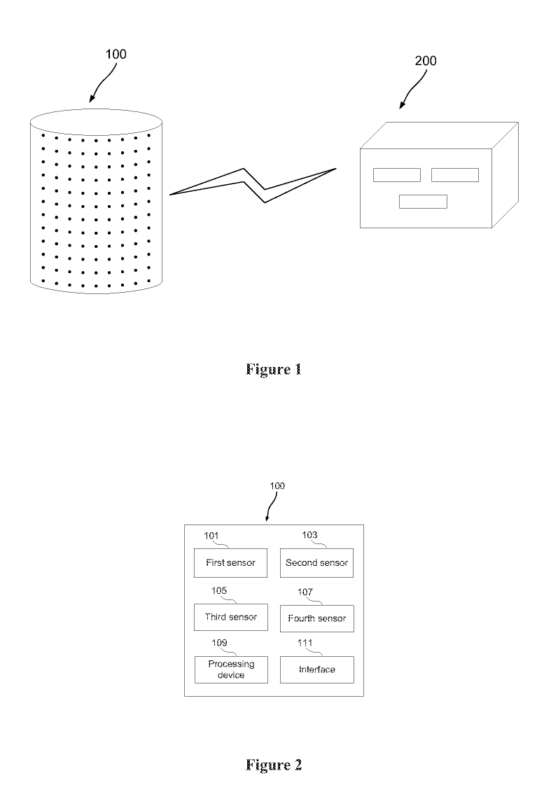

FIG. 1 schematically illustrates a playback system according to one or more embodiments. The playback system may include a speaker 100 and a media player 200. The speaker 100 may include at least one sensor for sensing gestures, and a processing device for generating control instructions based on the sensed gestures to control the media player 200. The speaker 100 may further include an interface for transmitting the control instructions to the media player 200. In FIG. 1, the interface may include a wireless communication device, such that the speaker 100 may transmit the control instructions to the media player 200 through wireless connection, such as by Wi-Fi, Bluetooth, or the like. In some embodiments, the interface may include a wired interconnection device, such as a cord, and the like. In some embodiments, the speaker 100 and the media player 200 may be integrated together. In such configuration, the interface may be omitted.

FIG. 2 schematically illustrates a block diagram of the speaker 100 according to one or more embodiments. Referring to FIG. 2, the speaker 100 may include a first sensor 101, a second sensor 103, a third sensor 105, a fourth sensor 107, a processing device 109 and an interface 111. The first, the second, the third and the fourth sensors 101, 103, 105 and 107 may sense gestures posed by a user and generate corresponding signals based on the sensed gestures. The processing device 109 may translate the corresponding signals into control instructions. And the interface 111 may transmit the control instructions to the media player 200. In some embodiments, a lookup table may be pre-established, which may store mappings between signals and their corresponding control instructions. Based on the lookup table, the processing device 109 may generate a control instruction corresponding to a signal arising from a specific gesture sensed by anyone of the first, the second, the third and the fourth sensors 101, 103, 105 and 107. Such that, the user can control playback of the media player 200 by posing gesture(s).

Hereunder give some examples of using gestures to control playback of the media player 200.

In some embodiments, the first sensor 101 may be adapted to sensing movements of an object within its sensing range. Normally, the user may use his/her hand to post a gesture. Therefore, in some embodiments, the first sensor 101 may sense the movements of the hand within its sensing range. Such that, if the hand conducts a predefined movement, the processing device 109 may generate a volume control instruction based on the predefined movement sensed by the first sensor 101. For example, if the first sensor 101 senses that the object is moving towards the first sensor, the processing device 109 may generate a volume-down instruction. If the first sensor 101 senses that the object is moving away from the first sensor, the processing device 109 may generate a volume-up instruction. In some embodiments, the volume-up instruction may be generated if the object is moving close to the first sensor 101, and the volume-down instruction may be generated if the object is moving away from the first sensor 101.

In some embodiments, the first sensor 101 may be a distance sensor capable of sensing a distance between the object and itself. Such that, whether the object is moving away from the first sensor 101 or moving towards the first sensor 101 may be determined based on a change of the sensed distance. The processing device 109 may make the determination and generate the volume control instruction accordingly.

Distance sensors are well known in the art. For example, the first sensor 101 may be a capacitance sensor which is able to sense proximity of the object. In some embodiments, the first sensor 101 may be attached to a surface of the shell of the speaker 100. For example, the first sensor 101 may be attached to a top surface of the speaker 100. Therefore, the user may control volume by putting his/her hand above the top surface. As long as the hand is within the sensing range of the first sensor 101, the distance between the hand and the first sensor 101 can be detected.

In some embodiments, the target volume value may be determined based on an absolute value of the distance between the object and the first sensor 101. For example, the target volume value may have a linear positive correlation with the distance value, where particular distance values correspond to particular volume levels, respectively. Once the first sensor 101 senses the object appears in its sensing range, it may generate a signal containing the distance information. The processing device 109 may translate the signal into a control instruction for setting the volume to a specific value corresponding to the distance value. The media player 200 may increase or decrease volume to the specific value according to the control instruction. In such configuration, the user can control the volume value by suspending the hand above the top surface of the speaker 100. The higher the hand is, the louder the sound will be, vise versa, which is easy for the user to understand and convenient to operate.

In some embodiments, whether to increase or decrease volume may be determined by whether the object is moving away from the first sensor 101 or moving close to the first sensor 101, i.e., whether the distance is increasing or decreasing. In such configuration, the user can gradually control the volume to increase or decrease from the current level to a desired level by pulling up or pressing down the hand. Specifically, the user may suspend the hand at a first position having a first distance from the first sensor 101, then move to a second position having a second distance from the first sensor 101. The first sensor 101 may sense the first distance and the second distance, and send them to the processing device 109. Correspondingly, the processing device 109 may generate a control instruction for increase or decrease volume based on the movement direction and distance. In some embodiments, if the processing device 109 determines that the distance increases, i.e., the second distance is greater than the first distance, it may generate a first volume control instruction to increase volume. In some embodiments, the processing device 109 may control the volume to be increased to an extent based on the difference between the second distance and the first distance, i.e., how much the distance sensed by the first sensor 101 changes. In some embodiments, if the processing device 109 determines that the distance decreases, it may generate a second volume control instruction to decrease volume. In some embodiments, the processing device 109 may control the volume to be decreased to an extent based on the difference between the second distance and the first distance.

It should be noted that, the corresponding relationship between the volume control instructions and the distance changes may be altered. For example, distance decreasing may result in a volume-up operation while distance increasing may result in a volume-down control.

In some embodiments, a predetermined movement should be conducted in advance to trigger the volume control operation. The processing device 109 may initiate the volume control operation when the first sensor 101 senses the predetermined movement of the object. Thereafter, the processing device 109 may control volume up or down based on the hand movement conducted after the predetermined movement. In some embodiments, the predetermined gesture may be the object staying still in the sensing range for at least a predetermined period of time, such as 1 or 2 seconds. The processing device 109 may determine whether the distance sensed by the first sensor 101 remains still for the predetermined period of time, i.e., whether the object conducts the predetermined movement, and if yes, generate the volume control instruction based on the distance change thereafter. In some embodiments, the processing device 109 may control the speaker 100 to give a notice if it determines that the suspending time of the object is greater than the predetermined period of time. Such that, the user may be noticed that volume control is triggered and he/she can start to move the hand to increase or decrease volume. The notice may be audible or visible. For example, the speaker 100 may generate a tick sound, or a light/screen mounted on the speaker 100 may be lighted up.

In some embodiments, the processing device 109 may transmit the volume control instruction to the media player 200 to control the volume of the media player 200. In some embodiments, the speaker 100 may control its own volume, so that the volume control instruction may be used to increase or decrease the volume of the speaker 100.

In some embodiments, the second sensor 103 may be a rotating sensor capable of sensing whether the speaker 100 is rotating and a rotating direction thereof. The second sensor 103 may be a gyroscope, an earth induction sensor, or the like, such that it can detect rotation of the speaker 100. The user can control the media player 200 to play a next file or a previous file by rotating the speaker 100 along a first rotating direction or a second rotating direction. Consequently, the second sensor 103 may generate a signal containing information of the rotating direction, and the processing device 109 may generate a control instruction to control playing a desired file based on the rotating direction. The first and the second rotating directions may be substantially opposite to each other. In some embodiments, the speaker 100 may have a cylindrical shape. The first rotating direction may be clockwise, and the second rotating direction may be anticlockwise.

In some embodiments, the third speaker 105 may sense whether the speaker 100 is shaking. For example, the third speaker 105 may be an accelerometer. The user may shake the speaker 105, which cause the third speaker 105 generating a signal based on which the processing device 109 may generate a control instruction to implement a shuffle operation. As a result, a playlist of the media player 200 may be reordered.

In some embodiments, the fourth sensor 107 may be a sensor capable of sensing touch. For example, the fourth sensor 107 may be a capacitance sensor. Once the user touch the fourth sensor 107, it may generate a signal based on which the processing device 109 may generate a control instruction to implement a play or pause operation.

As such, playback control can be implemented by intuitive and easy-to-understand gestures.

In some embodiments, the speaker 100 may be replaced by another control device, as long as the control device can sense object movements and generate control instructions based on the sensed movements. For example, a gesture control device may be provided according to at least one embodiment. The gesture control device may be in communication with an audio system, and may generate control instructions to control the playback of the audio system. The gesture control device may include a sensor and a processing device, detail configurations of them may be obtained by referring to above described descriptions.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A speaker, comprising:
a sensor adapted to sensing object movement within its sensing range; and
a processing device configured to generate a volume control instruction if the sensor senses one of the following movements of an object: movement away from the sensor, and movement towards the sensor.

2. The speaker according to claim 1, wherein the processing device is configured to:
generate a first volume control instruction to increase volume if the sensor senses the object's movement away from the sensor; and
generate a second volume control instruction to decrease volume if the sensor senses the object's movement towards the sensor.

3. The speaker according to claim 1, wherein the processing device is further configured to:
generate the volume control instruction to change volume to an extent based on a distance the object moves which is sensed by the sensor.

4. The speaker according to claim 1, wherein the processing device is further configured to:
determine whether the sensor senses the object staying still for at least a predetermined period of time before sensing the movement away from the sensor of the object or the movement towards the sensor of the object; and
if yes, generate the volume control instruction based on the movement away from the sensor of the object or the movement towards the sensor of the object.

5. The speaker according to claim 4, wherein the processing device is further configured to:
if the sensor senses the object staying still for at least the predetermined period of time, control the speaker to give an audible or visible notice for reminding a user to move the object.

6. A speaker, comprising:
a sensor adapted to sensing a distance between the sensor and an object in a sensing range of the sensor; and
a processing device configured to generate a volume control instruction based on the distance sensed by the sensor.

7. The speaker according to claim 6, wherein the processing device is configured to:
generate a first volume control instruction to increase volume if the distance sensed by the sensor increases; and
generate a second volume control instruction to decrease volume if the distance sensed by the sensor decreases.

8. The speaker according to claim 6, wherein the processing device is further configured to:
if the distance sensed by the sensor changes, generate the volume control instruction to change volume to an extent based on how much the distance changes.

9. The speaker according to claim 6, wherein the processing device is further configured to:
determine whether the distance sensed by the sensor remains still for at least a predetermined period of time before the distance changes; and
if yes, generate the volume control instruction based on a change of the distance.

10. The speaker according to claim 9, wherein the processing device is further configured to:
if the distance sensed by the sensor remains for at least the predetermined period of time, control the speaker to give an audible or visible notice for reminding a user to change the distance.

11. The speaker according to claim 6, further comprising a gesture control device for controlling an audio system, wherein
the sensor is further adapted for sensing object movement within its sensing range; and
the processing device is further configured to generate a corresponding volume control instruction to control the volume of the audio system if the sensor senses one of the following movements of an object: movement away from the sensor, and movement towards the sensor.

12. The speaker according to claim 11, wherein the processing device is further configured to:
generate a first volume control instruction to increase volume if the sensor senses the object's movement away from the sensor; and
generate a second volume control instruction to decrease volume if the sensor senses the object's movement towards the sensor.

13. The speaker according to claim 11, wherein the processing device is further configured to:
generate the corresponding volume control instruction to change volume of the audio system to an extent based on a distance the object moves which is sensed by the sensor.

14. The speaker according to claim 11, wherein the processing device is further configured to:
determine whether the sensor senses the object staying still for at least a predetermined period of time before sensing the movement away from the sensor of the object or the movement towards the sensor of the object; and
if yes, generate the corresponding volume control instruction based on the movement away from the sensor of the object or the movement towards the sensor of the object.

15. The speaker according to claim 14, wherein the processing device is further configured to:
if the sensor senses the object staying still for at least the predetermined period of time, control the gesture control device to give an audible or visible notice for reminding a user to move the object.

16. A method for controlling an audio system based on gesture, comprising:
a control device sensing movements of an object in its sensing range; and
generating a corresponding volume control instruction to control the volume of the audio system if one of the following movements of an object is sensed: movement away from the control device, and movement towards the control device.

17. The method according to claim 16, wherein the control device generates a first volume control instruction to increase the volume of the audio system if the object's movement away from the control device is sensed; and generates a second volume control instruction to decrease the volume of the audio system if the object's movement towards the control device is sensed.

18. The method according to claim 16, wherein the control device generates the volume control instruction to change the volume of the audio system to an extent based on a distance the object moves which is sensed by the control device.

19. The method according to claim 16, further comprising:
the control device determining whether the object stays still for at least a predetermined period of time before the movement away from the control device of the object or the movement towards the control device of the object is sensed; and
if yes, generating the volume control instruction based on the movement away from the control device of the object or the movement towards the control device of the object.

20. The method according to claim 19, further comprising:
if the object stays still for at least the predetermined period of time, the control device giving an audible or visible notice for reminding a user to move the object.
